(19) United States
(12) Patent Application Publication
(10) Pub. No.: US 2005/0264943 A1
(43) Pub. Date: Dec. 1, 2005

(54) Hard disk driving carriage and method of producing the same

(76) Inventors: Susumu Tsuchiya, Tokyo (JP); Minoru Sakino, Kitatsuru-gun (JP)

Correspondence Address: SUGHRUE MION, PLLC, 2100 PENNSYLVANIA AVENUE, N.W., SUITE 800, WASHINGTON, DC, 20037, US

(21) Appl. No.: 10/513,600

(22) PCT Filed: Apr. 30, 2003
(86) PCT No.: PCT/JP03/05518

§ 371 Date: Nov. 5, 2004

(30) Foreign Application Priority Data
May 9, 2002 (JP) 2002-134638
Jun. 3, 2002 (JP) 202-161658

(51) Int. Cl. G11B 5/55

(52) U.S. Cl. 360/265.9

(57) ABSTRACT

An object is to obtain a carriage for a hard disk driving actuator by a cheap cost in which an attaching intensity of the bearing can be sufficiently enhanced. Also, an object is to obtain a carriage plate in which it is possible to align a position for a plurality of carriage plates highly accurately with a high rigidity and a thin thickness and it is possible to enhance an attaching intensity to the bearing sufficiently. A carriage formed by a pressing operation by a press comprises a fixed bearing section, a fixed coil section, and an arm section. The thickness of the fixed bearing section is thicker than the thickness of the arm section and the fixed coil section. The rigidity in the arm section and the fixed coil section are higher than the rigidity in the fixed bearing section. It is acceptable if a plurality of longitudinal grooves which extend in an axial direction are formed on an inner wall of an attaching hole for the fixed bearing section so as to enhance the attaching accuracy of the bearing. An engaging protrusion or an engaging hole is formed near the fixed bearing section of the carriage plate so as to form the carriage by attaching the carriage plates by engaging these protrusions into the holes.

### BACKGROUND ART

The present invention relates to a carriage which forms an actuator for a hard disk drive which is built in a computer such as a personal computer and a method for manufacturing therefor. An object of the present invention is to simplify the manufacturing steps therefore.

As shown in FIG. 16, the actuator of the hard disk drive comprises a carriage 1, a suspension 2 which is attached to a tip of this carriage 1, a magnetic head 3 which is attached to a tip of this suspension 2, a bearing 4 which supports the carriage 1 axially and rotatively, a fixed magnet section 5 for the voice coil motor which rotates the carriage 1, and a movable coil 6 of the voice coil motor which is attached to a rear end of the carriage 1.

Here, the carriage 1 rotates by a movement of the voice coil motor. By doing this, the magnetic head 3 moves on the hard disk 8 by the spindle motor 7; thus, the position of the magnetic head 3 is determined.

Ordinarily, the carriage 1 in the actuator which has such a structure is made of an aluminum alloy for the purpose of reducing a weight. The carriage 1 is manufactured by various methods such as a die cast method, and a metal cutting method in which an extruded aluminum mold member is cut mechanically.

However, high accuracy is required for the carriage in these manufacturing methods. Therefore, there are many secondary manufacturing operations. Therefore, there was a disadvantage in that a manufacturing cost increases inevitably.

For a manufacturing method for solving this disadvantage, a method is proposed in which a plate member which is made of an aluminum alloy, etc. is formed by a pressing operation (punching operation) as few operations as possible. In such a manufacturing method, a plate member such as an aluminum alloy plate, etc. is disposed in a pressing metal mold so as to perform the pressing operation (punching operation); thus, the carriage 11 which has a shape as shown in FIG. 17 is manufactured instantly. Also, there is a case in which the carriage 11 is manufactured which has a shape as shown in FIGS. 18 and 19 by performing a secondary manufacturing operations according to necessity.

The carriage 11 which is shown in FIG. 17 comprises a fixed bearing section 12 in which the bearing 4 is attached, a fixed coil section 13 which extends from the fixed bearing section 12 backwardly such that the movable coil 6 is bonded and fixed thereon, and the arm section 14 which extends forwardly from the fixed bearing section 12 such that the above explained suspension 2 is fixed thereon; thus, the fixed bearing section 12 is in a plate manner.

Also, a drawing operation is performed to the aluminum alloy plate member which extends from the fixed coil section 13 and the arm section 14 such that the aluminum alloy plate member should be bent orthogonally to the arm section 14 so as to form a bent section in the fixed bearing section 12 in the carriage 11 which are shown in FIGS. 18, 19. The thickness of this part is drawn; thus, the thickness of this part is thicker than the thickness of the arm section 13 and the thickness of the fixed coil section 12.

However, in the carriage 11 which has such a shape, although it is possible to reduce the manufacturing cost, there are disadvantages below.

First, although the carriage 11 which is shown in FIG. 17 is assembled with other parts so as to be fixed to the bearing 4, it is not possible to fix it to the bearing 4 easily.

Also, there is a method for fixing the bearing and the carriage by a bonding method for a structure in which a drawing operation is performed so as to fix the bearing 4 and the carriage 11 as shown in FIGS. 18 and 19. However, the thickness of the bent section which contacts the bearing 4 of the fixed bearing section 12; thus, an attaching force (mechanical force) for the bearing 4 is low.

Also, the bent section is formed by a drawing operation; therefore it is not possible to obtain a certain thickness and the mechanical intensity with a sufficient length of the bent section. Therefore, there is a disadvantage in that it is not possible to enhance the attaching force (bonding force) for the bearing 4, etc.; therefore, there is a problem in that such a method is not practically useful.

Furthermore, in a case in which it is intended to realize a plurality of carriages 11 which are shown in FIG. 17, it was necessary to form a structure in which the subsidiary carriages 15 which is formed by the fixed bearing section 12 and the arm section 14, and the spacers 16 should be overlapped between the carriages 11 so as to determine intervals among them.

However, there was a disadvantage in that a cost increased due to the increase in the parts and the complicated manufacturing processes, and an accuracy in the dimension is reduced.

Similarly, if it is intended to realize a layered type of carriage by using the carriage 11 instead of the spacers, it was necessary to perform a bending operation or a drawing operation so as to realize a distance between the arms; thus, the thickness is thinner; therefore, there is a disadvantage in that the attaching force (mechanical intensity) with the bearing 4 is reduced to a great extent.

On the other hand, it is necessary to realize a carriage 1 for the actuator which has such a structure in which three magnetic heads are disposed so as to correspond to a large storage capacity type of the carriage in which a plurality of hard disks overlap; thus, a carriage 1 in which a plurality of arm sections are disposed so as to attach the magnetic heads 3 therein.

FIG. 21 shows an example for a carriage which has a plurality of such arm sections. In this example, the carriage 41 comprises two pieces of carriage plates 42, 42 and a piece of a coil plate 43.

The carriage plate 42 is made of an aluminum alloy plate which comprises a fixed bearing section 5 in which the hole 44 for fixing a bearing is formed and an arm section 46 in which the suspension is fixed.

Also, the coil plate 43 made of an aluminum alloy plate, etc. comprises a fixed bearing section 47 in which the hole 44 for fixing a bearing is formed and a branching fixed coil section 48 which sandwiches the movable coil so as to fix there.

In addition, these plates are assembled such that the coil plate 43 is sandwiched between two pieces of carriage plates 42, 42 such that the spacers 51, 51 are inserted so as to be overlapped onto each other. Also, the unit bearing 49 is inserted into the hole 44 for attaching a bearing in these plates 42, 42. Also, the unit bearing 49 is disposed on the receiving section 49b which is disposed so as to be protruded onto an outer surface of an outer wheel 49a of the unit bearing 49; thus a nut 50 is screwed from above the outer wheel 49a.

The carriage 41 which has such a structure is manufactured by forming the carriage plate 42 and the coil plate 43 by performing the pressing operation (punching operation) from an aluminum alloy plate member, and consequently, by assembly these members according to the above explained manner. Therefore, there were problems in that, there were many manufacturing steps, a cost for the manufacturing operations increased; thus, it was not possible to manufacture the product at a cheap cost, and it took time to determine the position of the carriage plate 42 and the coil plate 43.

Also, the arm section 46 and the fixed coil section 48 have low rigidity; therefore, it is necessary to increase the thickness of these members in order to increase a mechanical intensity. In such a case, there is a disadvantage in that a weight for an entire carriage is great. Furthermore, in such a structure, it is necessary to form a thread by performing a tapping operation to an outer wheel 49a of the unit bearing 49 and a nut 50 is necessary. Therefore, there was a problem in that it was difficult to reduce a cost for a unit bearing 49 which is used there.

Therefore, an object of the present invention is to obtain a carriage for an actuator for the hard disk drive which can enhance its attaching intensity sufficiently and to realize a very accurate layered type carriage even if a plurality of carriages are layered.

Also, other object of the present invention is to obtain a carriage for an actuator for a hard disk drive in which it is possible to align the position of the carriage plate easily, the carriage has a sufficient rigidity and its thickness can be reduced, its attaching intensity can be enhanced sufficiently, and in addition the carriage can be manufactured by a cheap cost.

Furthermore, another object is to obtain a method for manufacturing a carriage plate efficiently by a cheap cost.

### DISCLOSURE OF THE INVENTION

In order to solve the above problems, a first aspect of the present invention is a hard disk driving carriage which comprises a fixed bearing section and an arm section, wherein at least the arm section is formed by a compressing operation by a press such that a thickness of the arm section should be thinner than the thickness of the fixed bearing section so as to have a high rigidity.

A second aspect of the present invention is a hard disk driving carriage according to the first aspect of the present invention which further comprises a fixed coil section.

A third aspect of the present invention according to the second aspect of the present invention is a hard disk driving carriage such that the fixed coil section is formed by the compressing operation by a press such that the thickness of the fixed coil section should be thinner than the thickness of the fixed bearing section so as to have a high rigidity.

A fourth aspect of the present invention is a hard disk driving carriage according to any one of the first to the third aspect of the present invention such that the arm section and the fixed bearing section are formed unitarily by the pressing operation or the arm section and the fixed bearing section are formed unitarily by the pressing operation.

A fifth aspect of the present invention according to any one of the first to the fourth aspect of the present invention is a hard disk driving carriage such that a fixing hole of the fixed bearing section has an inner shape or an inscribing circle shape which is formed so as to fit an outer shape of the bearing which engages to the fixing hole.

A sixth aspect of the present invention is a hard disk driving carriage according to any one of the first to the fifth aspect of the present invention such that a thickness of a part which expands over the arm section of the fixed bearing section has ½ of the arm section or thicker.

A seventh aspect of the present invention is a hard disk driving carriage according to any one of the first to the sixth aspect of the present invention such that a part of a plurality of carriages which expand over the arm section of the fixed bearing section are disposed so as to be layered with each other such that spacers therebetween should not be necessary.

An eighth aspect of the present invention is a hard disk driving carriage plate which comprises a fixed bearing section and an arm section wherein an engaging protrusion or an engaging hole is formed near the fixed bearing section.

A ninth aspect of the present invention is a hard disk drive carriage plate according to the eighth aspect of the present invention which is formed unitarily by the pressing operation.

A tenth aspect of the present invention is a hard disk drive carriage plate according to the ninth aspect of the present invention such that the thickness of the arm section is formed so as to be thinner than the thickness of the fixed bearing section by the compressing operation by a press such that a pressing force is applied from the outside of the fixed bearing section.

An eleventh aspect of the present invention is a hard disk driving carriage such that at least two pieces of the carriage plate of any one of the eighth to the tenth aspect of the present invention are overlapped, and the engaging protrusions of these carriage plates are engaged to the engaging holes unitarily.

A twelfth aspect of the present invention is a method for manufacturing a hard disk driving carriage which comprises a fixed bearing section and an arm section comprising the steps for preparing a metal plate member, performing a compressing operation by a press onto a part which is supposed to be at least the arm section, wherein the thickness of the arm section should be thinner than the thickness of the fixed bearing section so as to have a higher rigidity.

A thirteenth aspect of the present invention is a method for manufacturing a hard disk driving carriage which comprises a fixed bearing section, an arm section, and a fixed coil section which comprises the steps for preparing a metal plate member, performing a compressing operation by a press onto a part which is supposed to be at least the arm section, wherein the thickness of the arm section should be thinner than the thickness of the fixed bearing section so as to have a higher rigidity.

A fourteen aspect of the present invention is a method for manufacturing a hard disk driving carriage according to the thirteenth aspect of the present invention such that the compressing operation is performed tot a part which is supposed to be the fixed coil section of the metal plate member such that the thickness of the fixed coil section should be thinner than the thickness of the fixed bearing section so as to have a higher rigidity.

A fifteen aspect of the present invention is a method for manufacturing a hard disk driving carriage according to any one of the twelfth to the fourteenth aspect of the present invention such that a thickness of a part which expands over the arm section of the fixed bearing section should be formed at ½ of the thickness of the arm section or thicker.

A sixteenth aspect of the present invention is a method for manufacturing a hard disk driving carriage according to any one of the twelfth to the fifteenth aspect of the present invention such that, in the compressing operation by a press for the metal plate member, a plurality of metal molds are switched successively, a final shape is realized successively while a plurality of pressing operations are performed which include at least a pressing operation.

A seventeenth aspect of the present invention is a method for manufacturing a hard disk driving carriage according to any one of the twelfth to the sixteenth aspect of the present invention such that at least a pressing operation is performed; and after that a blanking operation is performed in the pressing operation.

An eighteenth aspect of the present invention is a method for manufacturing a hard disk driving carriage according to any one of the twelfth to the sixteenth aspect of the present invention such that at least a pressing operation comprising the steps such as an operation for making prepared hole, a preparatory blanking operation, a compressing operation, a sizing operation, and an blanking operation such that these operations are performed successively.

A nineteenth aspect of the present invention is a method for manufacturing a hard disk driving carriage according to any one of the twelfth to the sixteenth aspect of the present invention such that a relationship such as t0≧t1>t2 is satisfied under condition that t0 indicates the thickness of the metal plate member, t1 indicates the thickness of the, and t2 indicates the thickness of the arm section.

A twentieth aspect of the present invention is a method for manufacturing a hard disk driving carriage according to any one of the twelfth to the sixteenth aspect of the present invention such that an object part for the compressing operation by a press is the arm section, or the arm section and the fixed bearing section, or the arm section, the fixed bearing section, and the fixed coil section.

### BRIEF DESCRIPTION OF DRAWINGS

FIG. 1 is an isometric view for an example for a carriage according to an embodiment 1 of the present invention.

FIG. 2 is a cross section for a carriage shown in FIG. 1.

FIG. 3 is a plan view for showing other example for the carriage.

FIG. 4A is a plan view for a modified example for a fixing hole of a fixed bearing section of the carriage.

FIG. 4B is a cross section for a fixing hole shown in FIG. 4A.

FIG. 5A is a plan view for other modified example for a fixing hole of a fixed bearing section of the carriage.

FIG. 5B is a cross section for a fixing hole shown in FIG. 5A.

FIG. 6 is an isometric view for an applied example of a carriage.

FIG. 7 is a cross section for a carriage shown in FIG. 6.

FIG. 8A is a plan view for showing other example for the carriage.

FIG. 8B is an isometric view for showing other example for the carriage.

FIG. 8C is a plan view for showing other example for the carriage.

FIG. 9 is a graph which shows a resonance characteristics of the carriage in a product of the present invention and a conventional product.

FIG. 10 is an isometric view for a first example for a carriage according to an embodiment 2 of the present invention.

FIG. 11 is a cross section for a carriage shown in FIG. 10.

FIG. 12 is a cross section for showing a second example for the carriage.

FIG. 13 is a cross section for showing a third example for the carriage.

FIG. 14 is a cross section for showing a fourth example for the carriage.

FIGS. 15A to F are cross sections for showing a general example in the embodiment 3 of the present invention in a step manner.

FIG. 16 is a plan view for showing an example for an actuator for a hard disk drive.

FIG. 17 is an isometric view for a conventional carriage.

FIG. 18 is an isometric view for other example for a conventional carriage.

FIG. 19 is a cross section for a conventional carriage shown in FIG. 18.

FIG. 20 is a disassembled isometric view for a conventional layered type carriage.

FIG. 21 is an isometric view for a conventional carriage.

### BEST MODE FOR CARRYING OUT THE INVENTION

### Embodiment 1

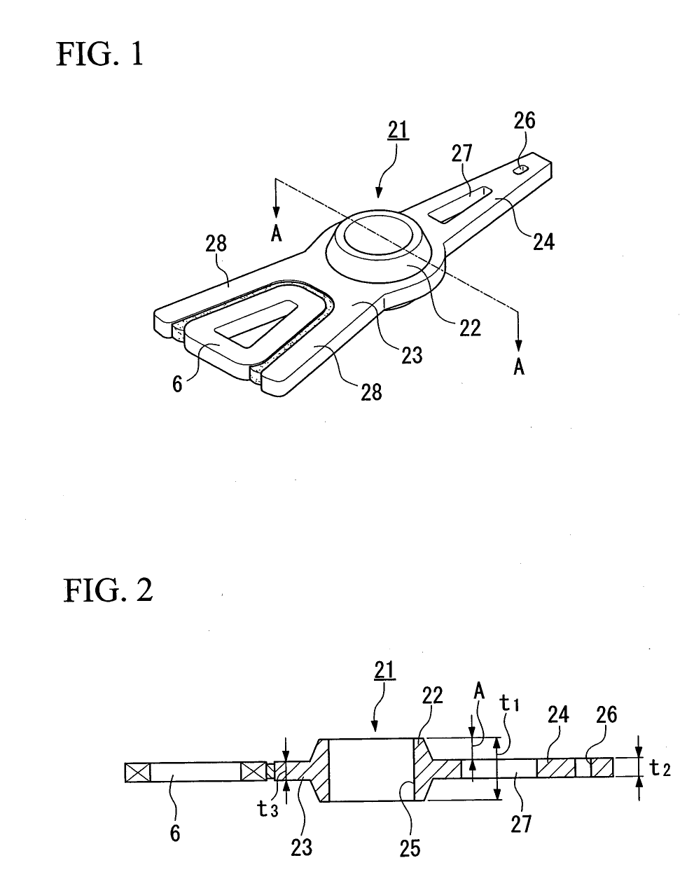

FIG. 1 and FIG. 2 show an example for a carriage according to an embodiment 1 of the present invention. A carriage 21 in this example is formed by an aluminum alloy, etc. such as 6061, 5052 which is formed by a pressing operation unitarily.

Here, in the pressing operation, a final shape for the carriage is realized by performing a pressing operation (pressing operation) for pressing a necessary part for a conventional punching operation. More specifically, as explained later in a method for manufacturing therefore, a member is used which is formed by a plate member which has a finished thickness (t1) or thicker than a finished thickness of the fixed bearing section 22 of which thickness is the thickest among the thicknesses of the carriage 21 such that the rest of the part other than the thick part in the fixed bearing section 22 is formed so as to be thinner; thus an entire carriage 21 should be forged sufficiently. Here, it depends on a designing operation for which part among the arm section, the arm section and the fixed bearing section, or the arm section, the fixed bearing section, and the fixed coil section is supposed to be objects for this pressing operation.

Also, this carriage 21 comprises a fixed bearing section 22, a fixed coil section 23, and an arm section 24.

The fixed bearing section 22 is a boss which has a fixing hole 25 through which the bearing is disposed such that its thickness (t1) expands outwardly from the arm section 24 and the fixed coil section 23 in a ring manner; thus, these thicknesses are quite thick.

The thickness (t2) of the arm section 24 and the thickness (t3) of the fixed coil section 23 are 0.7 to 1.6 mm; thus, they are thinner than the thickness (t1) of the fixed bearing section 22 such that a pressing operation is performed to a part of their material member in the pressing operation. Therefore, a metal organization is very fine such that a mechanical intensity such as tensile strength, an expansion, and a collision intensity is high; thus, the rigidity is high. Therefore, this arm section 24 and the fixed coil section 23 have sufficiently greater intensity than the rigidity in a member such as a plate which has the same thickness or a member which is formed by a die-cast member. Also, the thickness (A) in a part which expands over the arm section 24 of the fixed bearing section 22 has a thickness which is ½ of the thickness (t2) of the arm section 24 or greater.

The fixed coil section 23 has two arm sections 28, 28 which extends in a branched manner from the fixed bearing section 22 such that a movable coil 6 is engaged to an inside of these two arm sections 28, 28 so as to be fixed there.

Also, the thickness of this fixed coil section 23 is reduced greatly by the pressing operation; thus, by doing this, the metal organization is sufficiently fine. Therefore, a hardness is greater than that in the fixed bearing section 22, the rigidity is high, and a mechanical intensity such as a tensile strength, an expansion, and a collision intensity is high; thus, the rigidity is high. Therefore, it is possible to form the thickness of the fixed coil section 23 in a thin manner; thus, it is possible to realized a light weight fixed coil section 23.

The arm section 24 is an almost rectangular plate such that its base end section contacts the fixed bearing section 22 and an attaching hole 26 is formed on its tip to which a suspension is attached. Also, a vacancy 27 is opened on its central section for the purpose of realizing a light weight carriage. Also, the width is narrowed from the base end section toward the tip section gradually in a taper manner.

Also, the thickness of this fixed coil section 23 is similarly reduced greatly by the pressing operation; thus, by doing this, the metal organization is sufficiently fine. Therefore, a hardness is greater than that in the fixed bearing section 22, the rigidity is high, and a mechanical intensity such as a tensile strength, an expansion, and a collision intensity is high. Therefore, it is possible to form the thickness of the arm section 24 in a thin manner; thus, it is possible to realized a light weight fixed coil section 24.

In the carriage 21 which has such a structure, there are fewer manufacturing processes because the carriage 21 is manufactured in the pressing operation; thus, it is possible to reduce the manufacturing cost. Also, the shape of the fixed bearing section 22 is a thick boss shape; therefore, it mechanical intensity is great and an attaching intensity due to a bonded condition with the bearing is great.

Also, because it is manufactured in the pressing operation, the rigidity in an entire carriage 21 is enhanced. In particular, the rigidity in the fixed coil section 23 and the arm section 24 are enhanced furthermore. Thus, it is possible to realize a thinner fixed coil section 23 and thinner arm section 24. It is possible to realize a lighter weight. It is possible to enhance the resonance frequency of the carriage 21. It is possible to increase the operable frequency bandwidth so as to be higher.

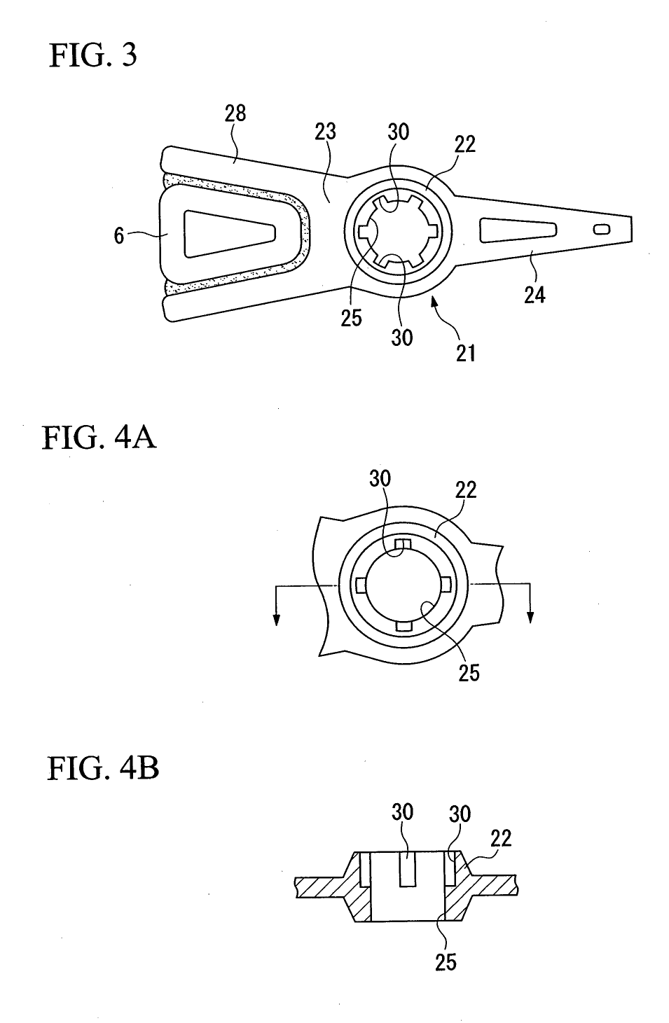

FIG. 3 shows other example for this carriage.

In this example for the carriage 21, a plurality of longitudinal grooves 30, 30 which extends in an axial direction on an inner wall of the fixing hole 25 of the fixed bearing section 22. This carriage 21 is also manufactured by the pressing operation similarly.

In this example for the carriage 21, it is possible to enhance an inner diameter of the attaching hole 25, a roundness, and a surface finish quality by etching such a longitudinal groove on the fixing hole 25.

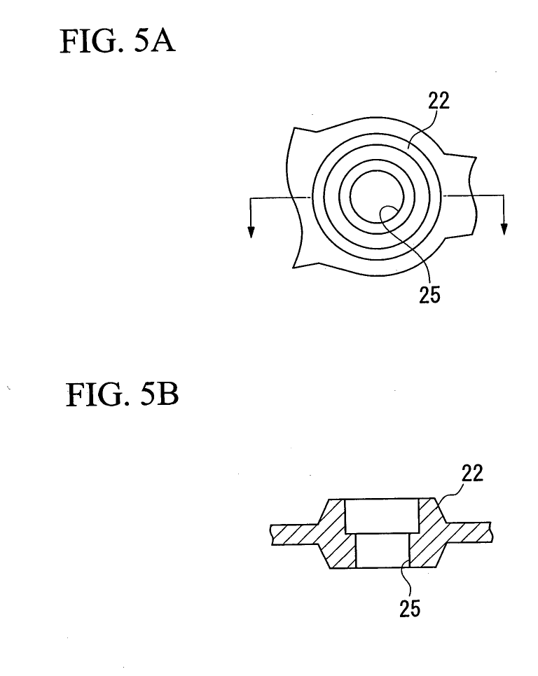

FIGS. 4A, B, and FIGS. 5A, B shows modified examples for the fixing hole 25 of the fixed bearing section 22. Four longitudinal grooves 30, 30 are formed in the middle of the inner wall of the fixing hole 25 in the examples shown in FIGS. 4A and 4B. In the member which is shown in FIG. 5, an opening of the fixing hole 25 has a greater diameter and the other opening has a smaller diameter such that a bearing can be inserted in this smaller diameter part.

In such a way, a fixing hole has an inner shape or an inscribing circle shape which is formed so as to fit an outer shape of the bearing which engages to the fixing hole 25.

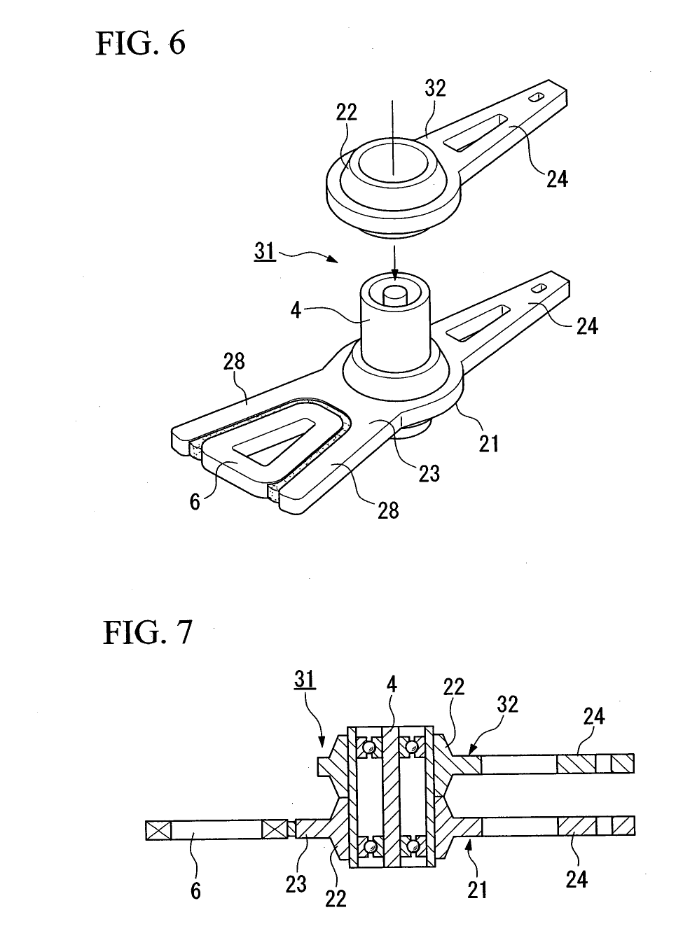

FIG. 6 and FIG. 7 show applied exampled for the carriage in which two carriages are layered. That is, the layered type carriage 31 has a structure in which a subsidiary carriage 32 which comprises the fixed bearing section 22 and the arm section 24 overlaps the carriage 21 which is shown in FIG. 1 and FIG. 2. Here, the subsidiary carriage 32 which lacks such a fixed coil section is included in the carriage of the present invention.

Such a subsidiary carriage 32 is manufactured by the pressing operation similarly such that the subsidiary carriage 32 has a shape in which the fixed coil section 23 of the carriage 23 which is shown previously is notched. As shown in the drawings, this subsidiary carriage 32 overlaps the carriage 21 such that the subsidiary carriage 32 is attached to the carriage 21 by disposing a long bearing 4 through the attaching holes 25, 25 on the fixed bearing sections 22, 22.

A part which expands outwardly from the fixed coil section 23 overlap with each other by layering them; by doing this, a certain interval is formed between the arm section 24 of the carriage 21 and the arm section 24 of the subsidiary carriage 32. It is acceptable if such an interval is made such that the hard disk 8 can be rotated at a high speed and the magnetic head 3 can be moved therebetween, and the interval is ½ of the thickness of the arm section 24.

Here, it is certainly needless to say that at least two subsidiary carriages 32 are layered so as to form a multi-stage layered type. In such a layered type, an expanding section serves as a spacer; therefore, it is not necessary to insert a spacer as a separate member in the carriages; thus, it is possible to perform a manufacturing operation by a cheap cost.

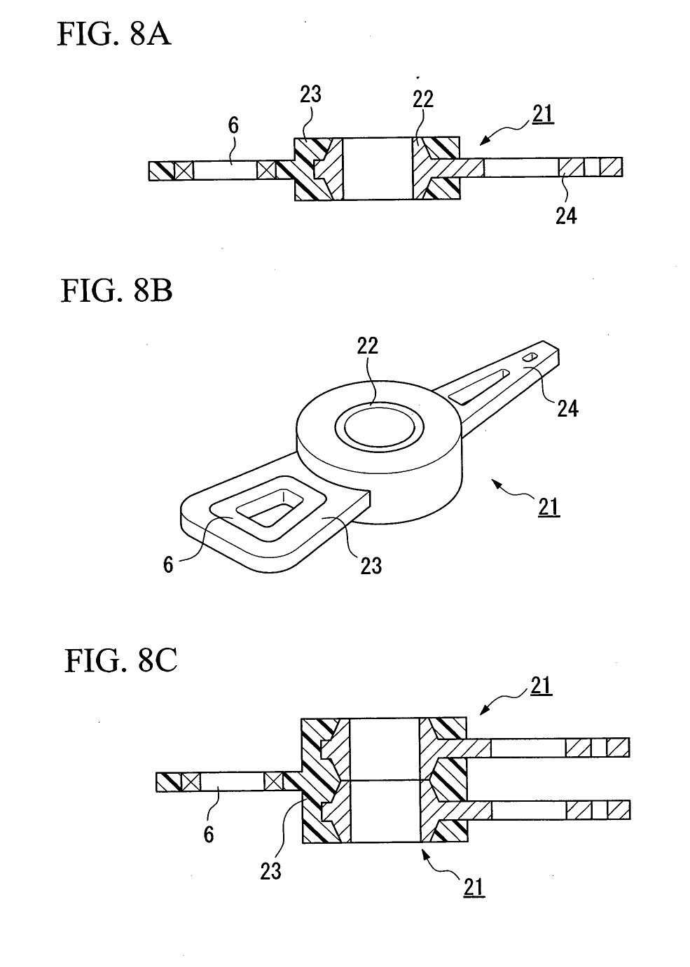

FIG. 8 shows other example for the carriage of the present invention. As shown in FIGS. 8(A), (B), the carriage 21 in this example is formed unitarily by forming the coil 6 and the fixed coil section 23 by a mold resin by performing an over mold when the coil 6 is fixed. Also, as shown in FIG. 8(C), it is acceptable if at least two carriages are layered so as to form the coil 6 and the fixed coil section 23 unitarily by the mold resin similarly.

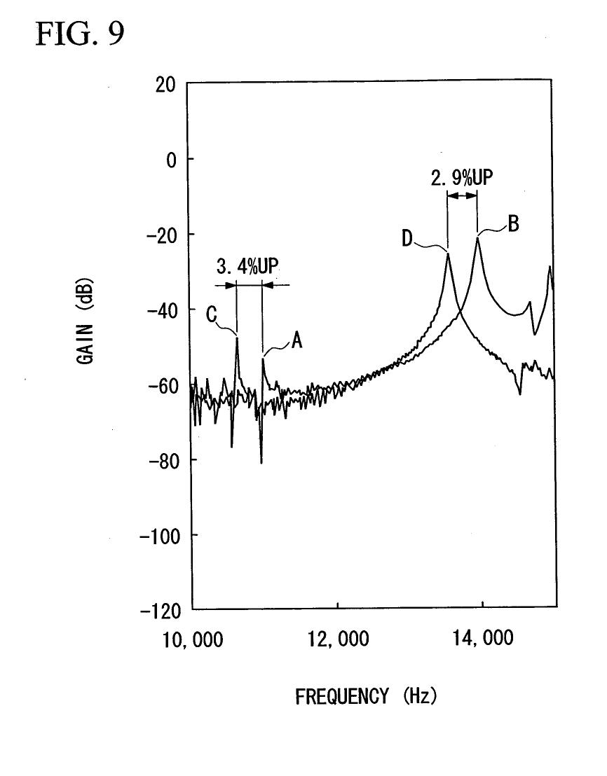

FIG. 9 is a view for showing a measurement result by a laser-Doppler meter of a resonance characteristics for the carriage which is manufactured by performing a conventional cutting operation for the same shape of member as the comparative example. In the present graph, a graph which is indicated by peaks A, B shows a characteristics of the carriage according to the present invention. A graph which is indicated by peaks C, D shows a characteristics of the comparative example. In this measurement sample, a pressing operation is performed by a press to an aluminum alloy plate which has 3 mm thickness, the measurement sample has a shape which is shown in FIG. 1, the thickness of the arm section and the thickness of the fixed coil section are 0.9 mm, the thickness of the fixed bearing section is 2.9 mm, the arm section has an approximately 10 mm length, an outer diameter of the fixed bearing section is approximately 10 mm, and the fixed coil section has approximately 15 mm length.

In the graph of FIG. 9, the peak A indicates a resonance peak in a torsion mode of the arm section. The peak B indicates a resonance peak in a four-dimensional torsion mode of the fixed coil section. Also, the peak C indicates a resonance peak at the torsion mode of the arm section in the carriage which is obtained in a conventional cutting operation such that the peak C has a similar dimension as a sample. The peak D indicates a resonance peak in a four-dimensional torsion mode of the fixed coil section similarly.

According to this graph, it is understood that the resonance frequency of the product according to the present invention moves nearer to a high frequency wavelength such that 3.4% of the torsion mode of the arm section, 2.9% of the fixed coil section move nearer to a high frequency wavelength. By doing this, it is possible to enhance a flexibility for a design of the carriage.

Next, a result of a measurement is shown which indicates that the arm section of the carriage according to the present invention has a high rigidity. In the present invention, the same sample as the comparative example is used for measuring the above resonance characteristics. The fixed bearing section of this carriage is fixed by a clamp, a loading force is applied on an innermore 2 mm position from the tip of the arm section; thus, the load is measured under condition that the tip of the arm section bends by 1 mm. When averages for the measured load is calculated under condition that there are three samples in any case, it is understood that: The product of the present invention indicates 710.3 g/mm².

The product of the conventional example indicates 630.7 g/mm².

According to this result, it was possible to confirm that the carriage of the present invention can enhance the rigidity approximately by 10% as compared to the carriage which is manufactured by a conventional cutting operation. Furthermore, it was confirmed that performing a pressing operation by such a press is an effective way for enhancing the rigidity of the carriage.

### Embodiment 2

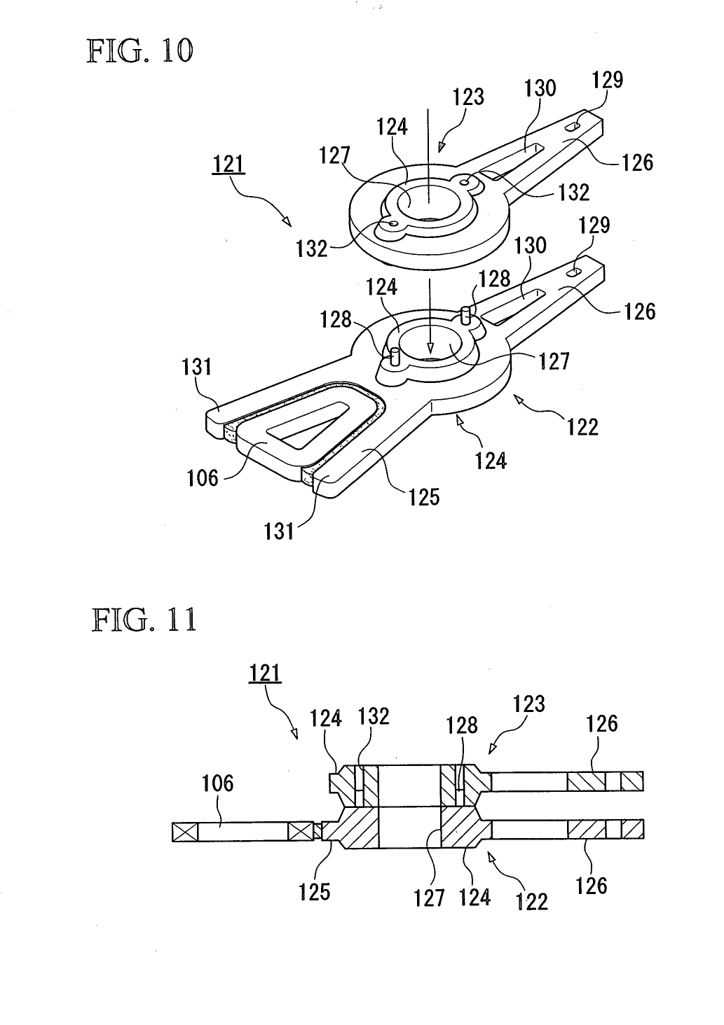

FIG. 10 and FIG. 11 show a first example for a carriage according to an embodiment 2. A carriage 121 in this example is formed by attaching a first carriage plate 122 and a second carriage plate 123 unitarily.

In addition, the first carriage plate 122 and the second carriage plate 123 are formed by an aluminum alloy member such as 6051, 5052 so as to be manufactured by a pressing operation.

Here, the pressing operation realize a final shape of the carriage by performing a pressing operation (pressing operation) onto a part to which a punching operation used bo be necessary in a conventional case.

More specifically, as explained later in a method for manufacturing therefore, a member is used which is formed by a plate member which has a finished thickness (t1) or thicker than a finished thickness of the fixed bearing section 24 of which thickness is the thickest among the thicknesses of the carriage plates 122, 123 such that the rest of the part other than the thick part in the fixed bearing section 124 is formed so as to be thinner; thus an entire carriage plates 122, 123 should be forged sufficiently.

Here, it depends on a designing operation for which part among the arm section, the arm section and the fixed bearing section, or the arm section, the fixed bearing section, and the fixed coil section is supposed to be objects for this pressing operation.

Also, the above first carriage plate 122 comprises the fixed bearing section 124, the fixed coil section 125, and the arm section 126.

The fixed bearing section 124 has a boss shape which has a fixing hole 127 through which the bearing is disposed such that its thickness expands outwardly from the arms section 126 and the fixed coil section 125 in a ring manner so as to form a boss so as to be thicker than the thickness of these members.

Also, the thickness of the arm section 126 and the thickness of the fixed coil section 125 are thinner than the thickness of the fixed bearing section 124 such that a pressing operation is performed to a part of their material member in the pressing operation. Therefore, a metal organization is very fine such that a mechanical intensity such as tensile strength, an expansion, and a collision intensity is high; thus, the rigidity is high. Therefore, this arm section 126 and the fixed coil section 125 have a sufficiently greater intensity than the rigidity in the fixed bearing section 124 which has the same thickness or a member which is formed by a die-cast member.

Furthermore, two columnar engaging protrusions 128, 128 are provided on an upper surface of this fixed bearing section 124. These two engaging protrusions 128, 128 are disposed symmetrically at a central axis of a bearing attaching hole 127 such that this protrusion 128 are disposed unitarily by the pressing operation at the same as forming the first carriage plate 122.

The fixed coil section 125 has two arm sections 131, 131 which extends in a branched manner from the fixed bearing section 124 such that a movable coil 106 is engaged to an inside of these two arm sections 131, 131 so as to be fixed there.

Also, the thickness of the fixed coil section 125 is reduced to a great extent. By doing this, a metal organization is very fine so as to have a greater hardness than that of the fixed bearing section 124, a mechanical intensity such as tensile strength, an expansion, and a collision intensity is high. Therefore, it is possible to form the thickness of the fixed coil section 125 in a thin manner; thus, it is possible to realized a light weight fixed coil section 125.

The arm section 126 is an almost rectangular plate such that its base end section contacts the fixed bearing section 124 and an attaching hole 129 is formed on its tip to which a suspension is attached. Also, a vacancy 130 is opened on its central section for the purpose of realizing a light weight carriage. Also, the width is narrowed from the base end section toward the tip section gradually in a taper manner.

Also, the thickness of the fixed coil section 126 is reduced to a great extent. By doing this, a metal organization is very fine so as to have a greater hardness than that of the fixed bearing section 124, a mechanical intensity such as tensile strength, an expansion, and a collision intensity is high. Therefore, it is possible to form the thickness of the fixed coil section 125 in a thin manner; thus, it is possible to realized a light weight fixed coil section 126.

The second carriage plate 123 comprises the fixed bearing section 124 and the arm section 126 without the fixed coil section such that these fixed bearing section 124 and the arm section 126 have a similar structure of the fixed bearing section 124 and the arm section 126 in the above explained first carriage plate 122.

However, the second carriage plate 123 is different from the first carriage plate 122 in that the second carriage plate 123 is provided with two engaging holes 132, 132 in its fixed bearing section 124.

The position, shape, and dimension for this engaging hole 132 is specified such that the engaging protrusion 128 of the first carriage plate 122 can be engaged when the first carriage plate 122 and the second carriage plate 123 are disposed so as to overlap with each other so as to align with the central axis of the bearing attaching hole 127.

Consequently, as shown in FIG. 11, the second carriage plate 123 is disposed on the first carriage plate 122, and the engaging protrusions 128, 128 which are disposed on the first carriage plate 122 are engaged to the engaging holes 132, 132 which are formed on the second carriage plate 123. By doing this, the first carriage plate 122 and the second carriage plate 123 are formed unitarily so as to form the carriage 121 in the present example.

It is possible to assemble the carriage 121 which has such a structure by engaging the engaging protrusion 128 on the first carriage plate 122 into the engaging hole 132 on the second carriage plate 123 easily. In addition, it is possible to assemble the carriage 21 in a high accuracy if the positions of the engaging protrusion 128 and the engaging hole 132 are formed accurately.

Also, the first carriage plate 122 and the second carriage plate 123 are manufactured by the pressing operation; therefore, the engaging protrusion 128 and the engaging hole 132 are formed unitarily; thus, it is possible to reduce a manufacturing steps and it is possible to manufacture a product by a cheap cost. Also, each carriage plate 122, 123 are sufficiently pressed in the pressing operation; therefore, the rigidity is high and a mechanical intensity is superior. In particular, it is possible to reduce the thickness of the arm section 126 and the fixed coil section 125; thus, it is possible to realize a light weight entirely, thus, it is possible to enhance the resonance frequency.

Furthermore, the shape of the fixed bearing sections 124, 124 of the first carriage plate 122 and the second carriage plate 123 are thick boss shapes; therefore, there is a larger area which contacts an outer wheel of the bearing when it is assembled with the bearing by using a bonding agent; thus, an attaching intensity with the bearing is high. Furthermore, it is not necessary to perform a tapping operation to the bearing and a nut is not necessary; therefore, it is possible to reduce the cost.

Here, the quantity and the position of such engaging protrusions and the engaging holes are determined by a design for the carriage; thus, it is possible to select any desirable quantity and position according to a necessity.

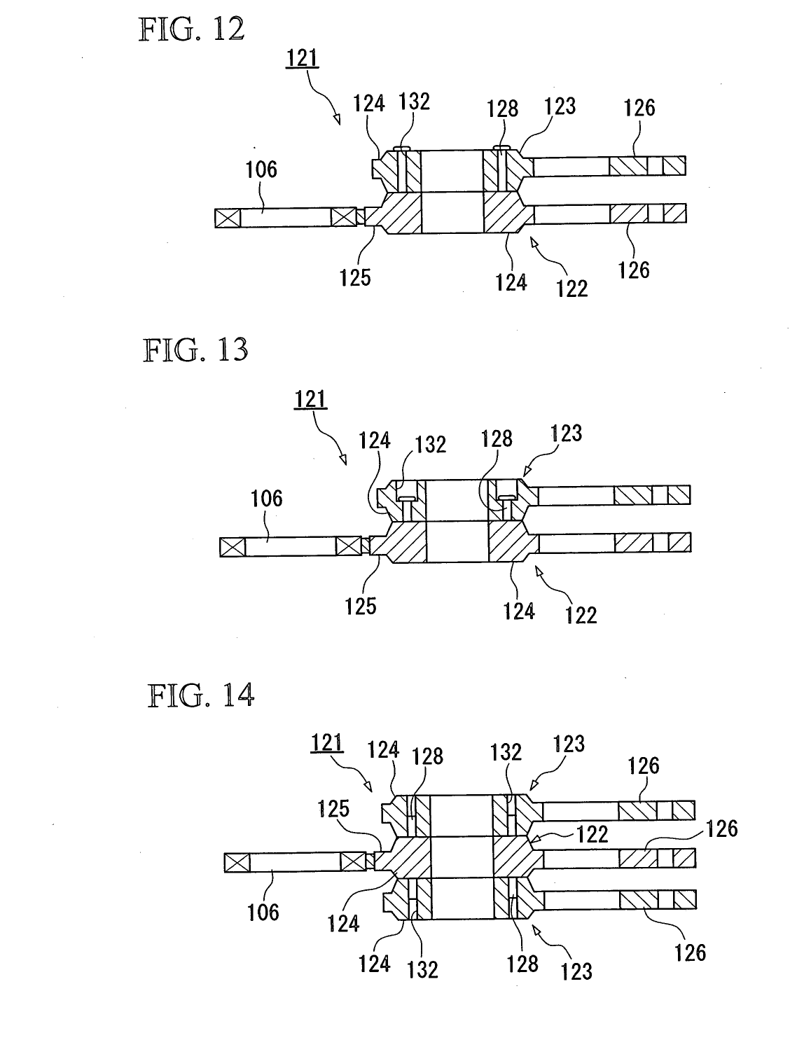

FIG. 12 shows a second example for this carriage. The carriage in the second example is different from the carriage in the first example in that the length of the engaging protrusion 128 which is disposed in the first carriage plate 122 is set so as to penetrate the engaging hole 132 which is formed in the second carriage plate 123 completely.

In this example, two carriage plates such as a first carriage plate 122 and a second carriage plate 123 are attached together. The engaging protrusion 128 of the first carriage plate 122 is engaged into the engaging hole 132 of the second carriage plate 123. After that, it is possible to form two carriage plates 122, 123 unitarily by performing a welding operation or a caulking operation to the tip of the engaging protrusion 128; thus, a complete unification and an electric conductance can be performed.

FIG. 13 shows a third example for this carriage. This member is formed by forming a facing spot in an opening section of the engaging hole 132 of the second carriage plate 123, engaging the engaging protrusion 128 into the engaging hole 132. After that, the tip of the engaging protrusion 128 is welded or caulked inside the facing spot; thus, two carriage plates 122, 123 are formed unitarily.

FIG. 14 shows a fourth example for this carriage. In this example, two engaging protrusions 128, 128 are formed on an upper surface of the fixed bearing section 124 of the first carriage plate 122. Also, two engaging protrusions 128, 128 are formed on a bottom surface of the fixed bearing section 124 of the first carriage plate 122; thus, totally four engaging protrusions are disposed in this example. Consequently, two carriage plates 123 which have s similar form of the carriage plate which is shown in FIG. 10 are attached together so as to sandwich the first carriage plate 122 by these two second carriage plates 123, 123.

Here, three pieces of carriage plates are formed unitarily by engaging the engaging protrusion 128 on an upper surface of the first carriage plate 122 into the engaging hole 132 of the second carriage plate 123 which is disposed on an upper surface of the first carriage plate 122, and by engaging the engaging protrusion 128 on a bottom surface of the first carriage plate 122 into the engaging hole 132 of the second carriage plate 123 which is disposed on a bottom surface of the first carriage plate 122. In this example, it is possible to obtain the carriage 121 in which three pieces of carriage plates 122, 123, 123 are formed unitarily and intensely.

Also, it is possible to form a carriage by disposing similar engaging protrusions and engaging holes on the carriage plate so as to layer at least four pieces of carriage plates unitarily. Also, it is acceptable if the engaging protrusions and the engaging holes are disposed on either the upper surface of the bottom surface of the fixed bearing section of the carriage plate. Also, it is acceptable if the engaging protrusions are formed on the upper surface and the engaging holes are formed on the bottom surface.

### Embodiment 3

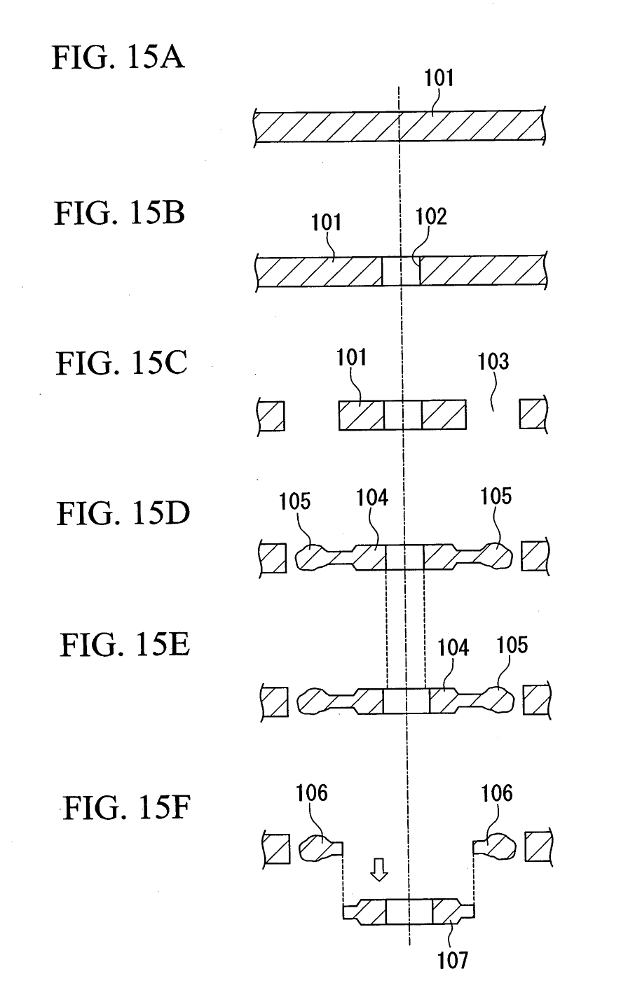

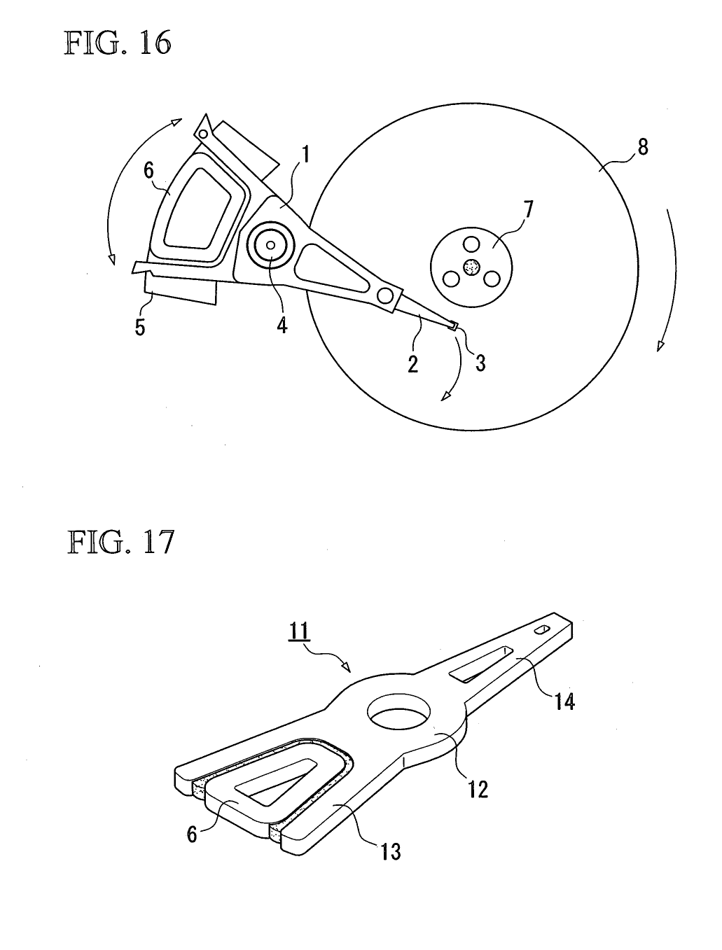

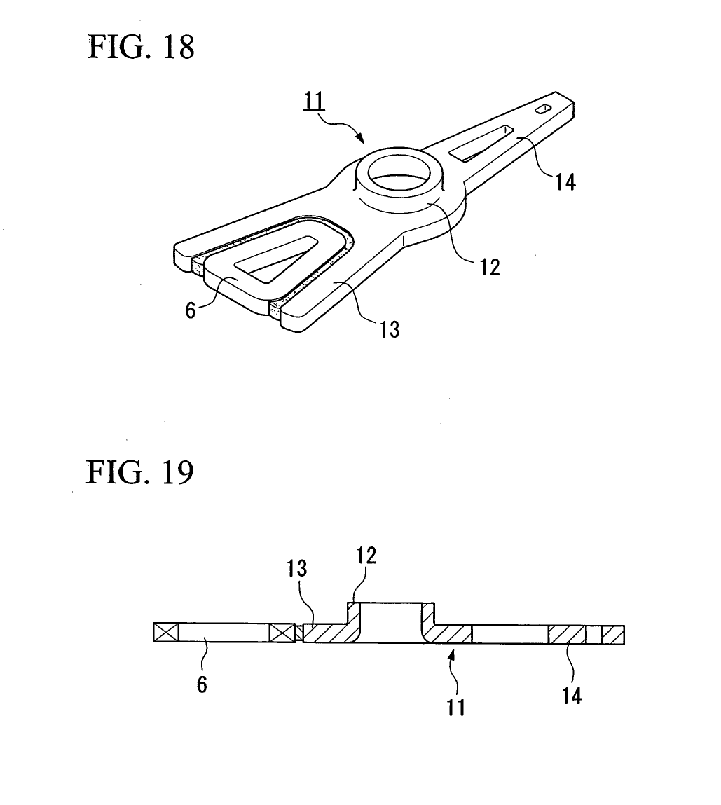

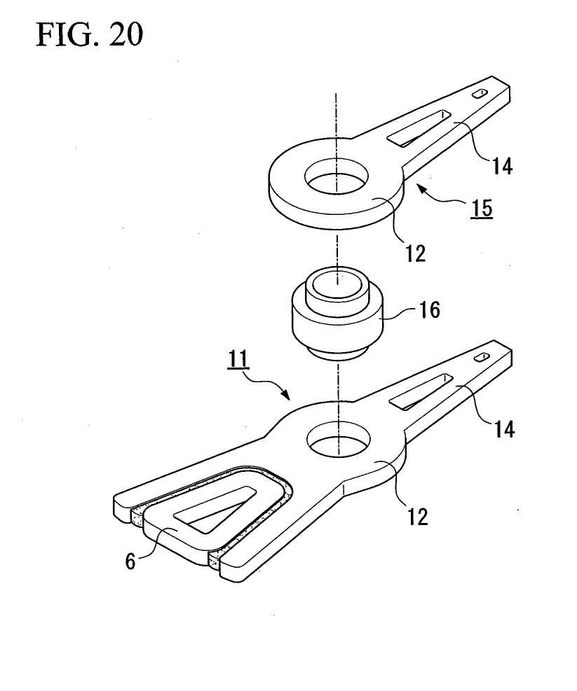

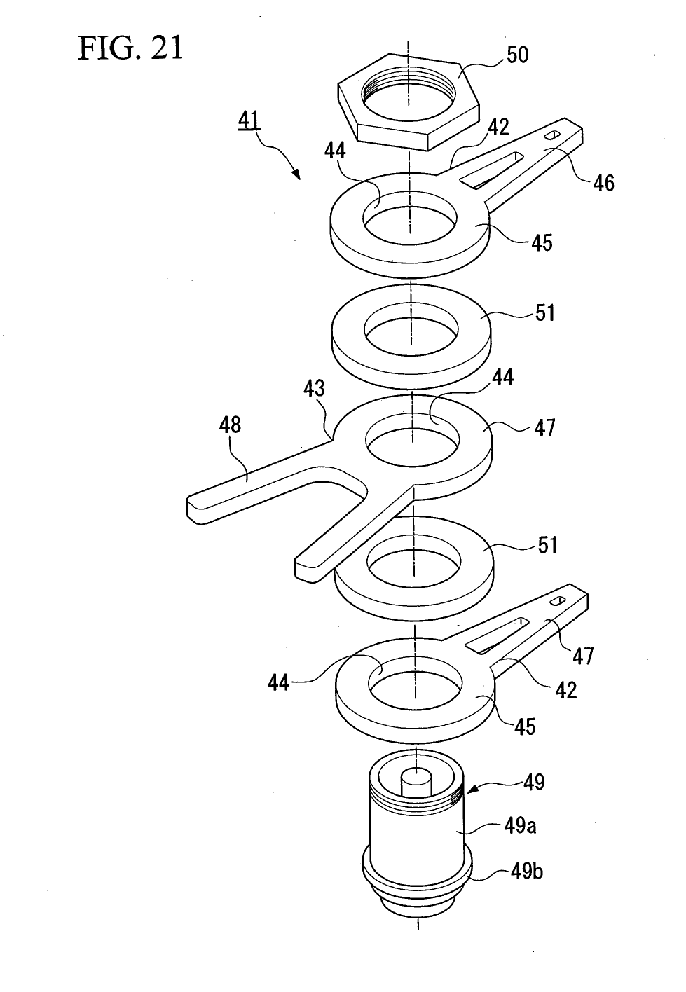

FIG. 15 shows an example for a method for manufacturing the carriage of the present invention in a step manner. This example shows a method for manufacturing the carriage which is shown in FIG. 1. In this carriage, a pressing operation is performed to an aluminum alloy plate which has 3 mm thickness, the thickness of the arm section and the thickness of the fixed coil section are approximately 0.9 mm, the thickness of the fixed bearing section is 2.9 mm, the arm section has approximately 15 mm length, an outer diameter of the fixed bearing section is approximately 10 mm, and the fixed coil section has approximately 15 mm length such that a modified condition which is caused by the pressing operation by the press to an A-A cross section which is shown in FIG. 1 is described graphically.

First, as shown in FIG. 15(A), an aluminum alloy plate member 101 as a base material is prepared. The thickness (t0) of the plate member 101 which is formed by an aluminum alloy such as 6061, 5052 is as thick as the thickness (t1) of the fixed bearing section 22 which is the thickest part of the carriage 21 or slightly thicker.

A member which is made by cutting this plate member 101 so as to be approximately the same as an outline of the carriage is prepared at first. This member is inserted into a metal mold which is not shown in the drawing, and a pressing operation is performed there. At first, as shown in FIG. 15(B), an operation for making a prepared hole is performed to this plate member 101 so as to make a preparatory hole 102. A diameter of this preparatory hole 102 is approximately 5 mm. This preparatory hole 102 serves as a guide hole for determining a position so as to perform a pressing operation later.

In a plurality of metal molds which are used in this manufacturing method have different cavity shapes which are formed therein with each other so as to exchange them preferably.

Consequently, as shown in FIG. 15(C), this plate member 101 is contained in other metal mold so as to perform a pressing operation and perform a preparatory blanking operation. Thus, a plate member 101 which is in a part separate from a preparatory hole 102 is punched; thus, an interval section 103 which has approximately several millimeters is formed on an outer surface. This interval section 103 serves as a clearance for a material member which is pressed and extruded in the next pressing operation. Although it is not shown in the drawing, an interval section 103 which serves as a clearance is formed in a most of the outer surface of the entire carriage. Here, if such an interval section is formed on an entire outer surface, the central part of the plate member 101 and the peripheral section are separated; thus, several sections thereof are connected.

Next, as shown in FIG. 15(D), other metal mold which is not shown in the drawing is used so as to perform a pressing operation; thus, a formed member 104 is obtained which has a slightly similar shape with the carriage. Members which correspond to the fixed bearing section 22, the fixed coil section 23, and the arm section 24 are formed in this formed member 104 such that the thickness of the arm section 24 is thinner than the thickness (t1) of the fixed bearing section 22, also, the thickness of the fixed coil section 23 is thinner than the thickness (t1) of the fixed bearing section. Also, the thickness (t1) of the fixed bearing section 22 is as thick as an initial thickness (t0) of the plate member 101 or slightly thinner.

Therefore, quite a portion of the arm section 24 and a quite a portion of the fixed coil section 23 are pressed, and a slight portion of the fixed bearing section 22 is pressed. During such a pressing operation, the material member 105 which is pressed and excluded flows into an interval section 103 which is formed in the previous step. The member which is shown in this drawing is molded so as to have the fixed bearing section 22 and its peripheral section in a shape similar to those in a final products.

Next, as shown in FIG. 15 (E), a sizing operation is performed by using other metal mold so as to obtain accurate dimensions in holes such as a hole of the fixed bearing section 22, a vacancy 27 of the arm section 24, and a section to which accuracy for dimension is strict.

At last, as shown in FIG. 15(F), an outer shape blanking operation is performed by using other metal mold so as to cut a necessary section 107 for the carriage except an unnecessary section 106 which is pressed and extruded so as to obtain a desirable carriage.

In the conventional manufacturing method which uses the pressing operation obtains a final product by performing an operation for making a prepared hole which is shown in FIGS. 15 (B), (E) and (F) and by performing a sizing operation and an outer shape blanking operation. Here, the conventional manufacturing method lacks the preparatory blanking operation and the pressing operation of the present invention.

Also, the manufacturing method according to the present invention is different from the conventional manufacturing method by the pressing operation in that the manufacturing method according to the present invention needs to perform the blanking operation such as separating and removing the section which is extruded by the pressing operation.

Here, it is acceptable if metal molds are disposed in a single metal mold, the successive transportation type plate member which has a tape manner is supplied so as to perform a similar operation as the previous plate member.

According to such a manufacturing method, it is possible to manufacture a carriage which has an accurate dimension with a high rigidity even if the thickness of the arm section and the fixed coil section are thin.

Also, it is possible to manufacture the carriage plate which is explained in the embodiment 2 by the above manufacturing method similarly.

As explained above, a carriage according to the present invention comprises a fixed bearing section and an arm section such that a thickness of the arm section should be thinner than the thickness of the fixed bearing section. Therefore, it is possible to simplify the manufacturing steps; therefore, it is possible to reduce the manufacturing cost. Also, the thickness of the fixed bearing section is thick; therefore, the mechanical intensity in this section is high. Thus, an attaching intensity with the bearing is high.

Furthermore, the carriage according to the present invention is manufactured by the pressing operation by using the press; therefore, a metal organization is fine with a high rigidity. In particular, it is possible to form a thickness of the arm section; thus, it is possible to realize a light weigh product. It is possible to shift the resonance frequency nearer to a high frequency wavelength. Thus, it is possible to enhance the flexibility of the design for the carriage.

Also, it is possible to enhance the attaching accuracy between the bearing and the carriage in a member in which a longitudinal groove, etc. is formed in an inner wall of the fixing hole of the fixed bearing section.

Furthermore, when at least two pieces of the carriages and the subsidiary carriages are layered, it is possible to realize a layered carriage by optimizing a pressing amount in the pressing operation such that a spacer therebetween is unnecessary with a desirable accuracy for a distance between the arm sections at a cheap cost.

Also, it is possible to simplify manufacturing steps and reduce the manufacturing cost with a desirable accuracy for attaching each carriage plate easily in a member which comprises the fixed bearing section and the arm section such that at least two carriage plates are layered in which the engaging protrusion or the engaging hole is formed near the fixed bearing section, and these engaging protrusion of these carriage plate is engaged into the engaging holes unitarily.

Also, according to a method according to the present invention for manufacturing the carriage, it is possible to manufacture the above explained carriage or the carriage plate efficiently.

### INDUSTRIAL APPLICABILITY

A hard disk driving carriage according to the present invention is used for a carriage for driving a hard disk device of a storage device such as a personal computer.

1. A hard disk driving carriage comprising a fixed bearing section and an arm section, wherein at least the arm section is formed by a compressing operation by a press such that a thickness of the arm section should be thinner than the thickness of the fixed bearing section so as to have a high rigidity.

2. A hard disk driving carriage according to claim 1 further comprising a fixed coil section.

3. A hard disk driving carriage according to claim 2 wherein the fixed coil section is formed by the compressing operation by a press such that the thickness of the fixed coil section should be thinner than the thickness of the fixed bearing section so as to have a high rigidity.

4. A hard disk driving carriage according to claim 1, 2, or 3 wherein the arm section and the fixed bearing section are formed unitarily by the pressing operation or the arm section and the fixed bearing section are formed unitarily by the pressing operation.

5. A hard disk driving carriage according to any one of claims 1 to 4 wherein a fixing hole of the fixed bearing section has an inner shape or an inscribing circle shape which is formed so as to fit an outer shape of the bearing which engages to the fixing hole.

6. A hard disk driving carriage according to any one of claim 1 to 5 wherein a thickness of a part which expands over the arm section of the fixed bearing section has ½ of the thickness of the arm section or thicker.

7. A hard disk driving carriage according to any one of claim 1 to 6 wherein a part of a plurality of carriages which expand over the arm section of the fixed bearing section are disposed so as to be layered with each other such that spacers therebetween should not be necessary.

8. A hard disk driving carriage plate comprising a fixed bearing section and an arm section wherein an engaging protrusion or an engaging hole is formed near the fixed bearing section.

9. A hard disk drive carriage plate according to claim 8 which is formed unitarily by the pressing operation.

10. A hard disk drive carriage plate according to claim 9 wherein the thickness of the arm section is formed so as to be thinner than the thickness of the fixed bearing section by the compressing operation by a press such that a pressing force is applied from the outside of the fixed bearing section.

11. A hard disk driving carriage wherein: at least two pieces of the carriage plate of any one of claims 8 to 10 are overlapped; and the engaging protrusions of these carriage plates are engaged to the engaging holes unitarily.

12. A method for manufacturing a hard disk driving carriage which comprises a fixed bearing section and an arm section comprising the steps for:
preparing a metal plate member;
performing a compressing operation by a press onto a part which is supposed to be at least the arm section, wherein the thickness of the arm section should be thinner than the thickness of the fixed bearing section so as to have a higher rigidity.

13. A method for manufacturing a hard disk driving carriage which comprises a fixed bearing section, an arm section, and a fixed coil section comprising the steps for:
preparing a metal plate member; performing a compressing operation by a press onto a part which is supposed to be at least the arm section, wherein the thickness of the arm section should be thinner than the thickness of the fixed bearing section so as to have a higher rigidity.

14. A method for manufacturing a hard disk driving carriage according to claim 13 wherein the compressing operation is performed tot a part which is supposed to be the fixed coil section of the metal plate member such that the thickness of the fixed coil section should be thinner than the thickness of the fixed bearing section so as to have a higher rigidity.

15. A method for manufacturing a hard disk driving carriage according to any one of claim 12 to 14 wherein a thickness of a part which expands over the arm section of the fixed bearing section should be formed at ½ of the thickness of the arm section or thicker.

16. A method for manufacturing a hard disk driving carriage according to any one of claim 12 to 15 wherein, in the compressing operation by a press for the metal plate member:
a plurality of metal molds are switched successively;
a final shape is realized successively while a plurality of pressing operations are performed which include at least a pressing operation.

17. A method for manufacturing a hard disk driving carriage according to any one of claim 12 to 16 wherein at least a pressing operation is performed; and after that a blanking operation is performed in the pressing operation.

18. A method for manufacturing a hard disk driving carriage according to any one of claim 12 to 16 wherein at least a pressing operation comprising the steps such as an operation for making prepared hole, a preparatory blanking operation, a compressing operation, a sizing operation, and an blanking operation such that these operations are performed successively.

19. A method for manufacturing a hard disk driving carriage according to any one of claim 12 to 16 wherein a relationship such as t0≧t1>t2 is satisfied under condition that t0 indicates the thickness of the metal plate member, t1 indicates the thickness of the, and t2 indicates the thickness of the arm section.

20. A method for manufacturing a hard disk driving carriage according to any one of claim 12 to 16 wherein an object part for the compressing operation by a press is the arm section, or the arm section and the fixed bearing section, or the arm section, the fixed bearing section, and the fixed coil section.
